(19) United States
(12) Patent Application Publication
(10) Pub. No.: US 2010/0316916 A1
(43) Pub. Date: Dec. 16, 2010

(54) POLYMER ELECTROLYTE FUEL CELL SYSTEM

(76) Inventors: Shinsuke Takeguchi, Osaka (JP); Yoichiro Tsuji, Osaka (JP); Hiroki Kusakabe, Osaka (JP)

Correspondence Address: MCDERMOTT WILL & EMERY LLP, 600 13TH STREET, NW, WASHINGTON, DC, 20005-3096, US

(21) Appl. No.: 12/446,214

(22) PCT Filed: Oct. 17, 2007
(86) PCT No.: PCT/JP2007/070229

§ 371 Date: Apr. 17, 2009

(30) Foreign Application Priority Data
Oct. 17, 2006 (JP) 2006-282929

(51) Int. Cl. H01M 8/04; H01M 8/10; H01M 8/02

(52) U.S. Cl. 429/413; 429/430

(57) ABSTRACT

A polymer electrolyte fuel cell system of the present invention comprises cells 10, a stack 100, a temperature control device (160, 140, 40, 41), an anode gas supplier 110, a cathode gas supplier 120, and a controller 300. When a power generation output of the stack 100 is reduced, the controller 300 controls the anode gas supplier 110 and the cathode gas supplier 120 to reduce a supply amount of the anode gas and a supply amount of the cathode gas, and controls at least one of the anode gas supplier 110, the cathode gas supplier 120, and the temperature control device 100 to cause a dew point temperature of a gas supplied to at least one of the anode gas channels and the cathode gas channels to be higher relative the temperature of the stack 100 so that the gas becomes supersaturated or more supersaturated than prior to causing the dew point temperature of the gas to be higher.

### TECHNICAL FIELD

The present invention relates to a polymer electrolyte fuel cell system using a polymer electrolyte fuel cell.

### BACKGROUND ART

In general, a polymer electrolyte fuel cell system (hereinafter referred to as a PEFC system) is configured to include cells each including an anode separator plate provided with anode gas channels, a cathode separator plate provided with cathode gas channels, and an MEA sandwiched between these, a stack including the cells which are stacked and is provided with heat transmission medium channels connecting inlets and outlets for a heat transmission medium between the surfaces of the cells stacked, a temperature control device for controlling a temperature of the stack, an anode gas supplier to supply an anode gas to the stack, a cathode gas supplier to supply a cathode gas to the stack, and a controller configured to control an operation state of the temperature control device, the anode gas supplier, and the cathode gas supplier.

In an electrochemical reaction of the PEFC system, it is necessary to make a polymer electrolyte membrane sufficiently wet as illustrated in patent documents 1 and 2.

In particular, patent document 1 discloses a PEFC system which is capable of supplying the anode gas and the cathode gas whose dew point temperatures are about 2° C. higher than the temperature of the MEA so that the entire region of the MEA can be surely kept in water-saturated state.

On the other hand, the PEFC system has a problem that a phenomenon occurs in which a power generation output becomes unstable or performance deteriorates due to the fact that water condenses in a gas passage inside the cell or inside an electrode and water clogging arises, namely, a flooding phenomenon occurs. In particular, during the state where the power generation output of the stack is low (hereinafter referred to as low power output state), the flooding phenomenon tends to occur. To be specific, since the consumption amount of the anode gas and the consumption amount of the cathode in the stack gas are reduced during the low power output state, the anode gas supplier and the cathode gas supplier reduce the supply amounts of these gases. For this reason, the speeds and supply pressures of these gases in the anode gas channels and the cathode gas channels in the cells are reduced, deteriorating a discharge ability of condensed water by the pressures of these gases.

To solve such a problem, various PEFC systems have been proposed, which suppress the generation of condensed water in the interior of the cells or facilitate the removal of the condensed water from the interior of the cells.

Patent document 3 discloses a method in which the structure of anode gas channels and the structure of cathode gas channels are devised to increase the amount of migration of the anode gas and the cathode gas per time to facilitate discharging of the water from the interior of the cells.

Patent document 4 discloses a method in which, when the power generation output becomes unstable, the generation of condensed water in the interior of the cells is suppressed by increasing the temperature of the cells or reducing a humidification amount of at least either one of the anode gas and the cathode gas. In addition, patent document 4 discloses an operation method in which when the power generation output becomes unstable, the removal of the condensed water from the interior of the cells is facilitated by increasing the supply amount of at least either one of the anode gas and the cathode gas.

Patent document 5 discloses a method of operating a PEFC system in which a flow direction of the anode gas and the cathode gas in the cells is switched to a vertical direction, when the flooding phenomenon occurs. That is, patent document 5 discloses a technique in which a gravitational force is utilized to facilitate discharging of the condensed water from the interior of the cells.

Patent document 6 discloses a method of operating a PEFC system in which a fastening force of a stack is increased during a low power output state. By increasing the fastening force, the channel cross-sectional areas of the anode gas channels and the cathode gas channels in the interior of the cells are made small, and hence the speeds of the gases flowing in these channels are increased. This makes it possible to facilitate discharging of the condensed water from the interior of the cells.

Patent document 7 discloses a technique for adjusting the surface characteristics of the anode gas channels and the cathode gas channels.

Patent document 1: Japanese Laid-Open Patent Application Publication No. 2005-203361
Patent document 2: Japanese Laid-Open Patent Application Publication No. 2002-164069
Patent document 3: Japanese Laid-Open Patent Application Publication No. 2003-272676
Patent document 4: Japanese Laid-Open Patent Application Publication No. 2001-148253
Patent document 5: Japanese Laid-Open Patent Application Publication No. 2003-142133
Patent document 6: Japanese Laid-Open Patent Application Publication No. 2004-253269
Patent document 7: Japanese Patent Publication No. 3739386

### DISCLOSURE OF THE INVENTION

### Problems to be Solved by the Invention

The PEFC system of patent document 1 includes a controller configured to control the dew point temperature of the anode gas and the dew point temperature of the cathode gas. This makes it possible to keep the entire region of the MEA water-saturated more surely. As a result, drying of the polymer electrolyte membrane during the low power output state can be prevented. However, the aforesaid controller executes control so that a dew point temperature (T2) of the fuel gas is a certain value higher than a temperature (T3) of the fuel gas passage inlet, thereby preventing the flooding. That is, regardless of whether the power generation output is high or low, a temperature difference between the temperature of the stack and the dew point temperature of the fuel gas is allowed to fall within a certain range, thereby enabling prevention of the occurrence of the instable state of the power generation output. Therefore, the patent document 1 does not disclose or suggest the technique for making the fuel gas supersaturated or more saturated according to a reduction in the power generation output (see patent document 1 paragraphs [0099] to [0112]).

The special structure of the cells disclosed in patent documents 3 and 5 makes the structure of the cells complex.

The operation method disclosed in patent document 4 in which the humidification amount of the anode gas and the humidification amount of the cathode gas are reduced or the temperature of the cells is increased may cause the insufficient wet state of the polymer electrolyte membrane, leading to damage to the polymer electrolyte membrane.

In the technique disclosed in patent document 6, the fastening force must be adjusted every time the power generation output of the PEFC system fluctuates. This may progress deterioration of the fastening structure of the stack and hence shorten a life of the stack.

Patent document 7 discloses a separator plate for the PEFC which is excellent in water discharge ability, but does not disclose or suggest a technique for attaining stabilization of the power generation output during the low power output state of the PEFC system.

Under the circumstances, there has been a room for improvement in the PEFC system for stabilizing the power generation output during the low power output state.

The present invention has been made to solve the above described problems, and an object of the present invention is to provide a PEFC system which is capable of stabilizing a power generation output even during a low power output state without making a structure of the PEFC system complex and without causing a possibility of an insufficient wet state of a polymer electrolyte membrane.

### Means for Solving the Problems

The inventors studied intensively to solve the above described problems. As a result, the inventions found the following and conceived the present invention.

In general, persons skilled in the art consider that, if the supply amount of the gases is reduced during the low power output state, a discharge effect of the condensed water produced by the gases are lessened and thereby the condensed water tends to be stagnant in the anode gas channels and the cathode gas channels, making the power generation output of the stack unstable, as disclosed in patent documents 3 to 6.

However, the inventors found a phenomenon in which the discharging of the water is facilitated by increasing the amount of the condensed water generated in the anode gas channels and the cathode gas channels. That is, they found that if the supply amount of the gas is reduced during the low power output state, the power generation output is stabilized by placing the anode gas channels and the cathode gas channels in the state where the condensed water is easily generated therein. It is not clear why such a phenomenon occurs. The inventors presume that the condensed water is taken into water films formed on the surfaces of the channels and is easily pushed away.

Based on the above new finding, a polymer electrolyte fuel cell system of the first invention of the present invention comprises cells each including an anode separator plate provided with anode gas channels, a cathode separator plate provided with cathode gas channels, and a MEA sandwiched between the anode separator plate and the cathode separator plate; a stack including the cells stacked; a temperature control device for controlling a temperature of the stack; an anode gas supplier to supply an anode gas having a steam partial pressure to the anode gas channels; a cathode gas supplier to supply a cathode gas having a steam partial pressure to the cathode gas channels; and a controller configured to control the temperature control device, the anode gas supplier, and the cathode gas supplier; wherein when a power generation output of the stack is reduced, the controller controls the anode gas supplier and the cathode gas supplier to reduce a supply amount of the anode gas and a supply amount of the cathode gas, and controls at least one of the anode gas supplier, the cathode gas supplier, and the temperature control device to cause a dew point temperature of a gas supplied to at least one of the anode gas channels and the cathode gas channels to be higher relative to the temperature of the stack so that the gas becomes supersaturated or more supersaturated than prior to causing the dew point temperature of the gas to be higher.

In such a configuration, a power generation output can be stabilized even during a low power output state without making the structure of the PEFC system complex and without causing a possibility of an insufficient wet state of the polymer electrolyte membrane.

In the polymer electrolyte fuel cell system of the second invention of the present invention, at least one of the anode gas channels and the cathode gas channels may have a surface having a contact angle of 90 degrees or smaller.

In such a configuration, since the surfaces of these channels have a highly hydrophilic property rather than a water-repellent property, the advantage of the first invention of the present invention is effectively attainable.

As used herein, the term “contact angle” refers to an angle (internal angle of a water droplet) formed between a liquid surface and the surface of the channel at a location where a free surface of the water droplet is in contact with the surface of the channel (see page 690 of fourth edition of Iwanami Rikagaku Jiten). More specifically, the “contact angle” refers to an angle formed between a horizontally oriented surface of the channel and the liquid surface of a specified amount of the water droplet placed in stationary state on the surface of the channel.

In the polymer electrolyte fuel cell system according to the third invention of the present invention, at least one of the anode separator plate and the cathode separator plate may be a compression-molded separator plate manufactured by compression-molding of a mixture containing electrically conductive carbon and binder; and at least one of the anode gas channels and the cathode gas channels formed on the compression-molded separator plate may have a surface subjected to a hydrophilic property improvement treatment.

Since the hydrophilic property of the surface of the compression-molded separator plate is improved, the advantage of the first invention of the present invention is effectively attainable.

As used herein, the term “hydrophilic property improvement treatment” refers to a treatment performed for increasing minute concave-convex regions (i.e., specific surface area) or polarities on the surface of the channel to enable the surface of the channel to have a hydrophilic property. As examples of techniques of the hydrophilic property improvement treatment, there are an etching process, a blasting process, a polishing process, a glow discharge process, and an oxygen plasma process.

In the polymer electrolyte fuel cell system according to the fourth invention of the present invention, the hydrophilic property improvement treatment may be an oxygen plasma treatment.

In such a configuration, since the hydrophilic property improvement treatment can be carried out properly, the advantage of the third invention of the present invention is attainable properly.

In the polymer electrolyte fuel cell system according to the fifth invention of the present invention, the controller may control the temperature control device to lower the temperature of the stack, when the power generation output of the stack is reduced.

Such a configuration can omit the control for the dew point temperature of the anode gas and the dew point temperature of the cathode gas in the anode gas supplier and the cathode gas supplier. Therefore, the control for the factors other than the supply amounts of the gases in the anode gas supplier and the cathode gas supplier can be simplified. As a result, the present invention can be carried out more easily.

In the polymer electrolyte fuel cell system according to the sixth invention of the present invention, the stack may have heat transmission medium channels each of which is formed between surfaces of the cells stacked, the temperature control device may be a heat transmission medium supplier configured to supply the heat transmission medium to the heat transmission medium supply passage and to control at least one of a temperature and a flow rate of the heat transmission medium which is a controlled target; and the controller may control the controlled target to lower the temperature of the stack, when the power generation output of the stack is reduced.

In such a configuration, the polymer electrolyte fuel cell system enables the use of heat of the heat transmission medium and the heat transmission medium supplier is the temperature control device. Therefore, the polymer electrolyte fuel cell system can have a rational construction.

In the polymer electrolyte fuel cell system according to the seventh invention of the present invention, the heat transmission medium supplier may be configured to control a temperature of the heat transmission medium; and the controller may cause the temperature of the heat transmission medium to be lowered to lower the temperature of the stack, when the power generation output of the stack is reduced.

The operation method for increasing the supply amount of the gases or cell temperature as disclosed in patent document 4 consumes energy for increasing the amount and the temperature, or reduces the energy recovered from the heat transmission medium. This reduces energy efficiency of the polymer electrolyte fuel cell system. However, since the above configuration makes it possible to lower the temperature of the heat transmission medium supplied to the stack, the energy efficiency of the polymer electrolyte fuel cell system can be improved.

In the polymer electrolyte fuel cell system according to the eighth invention of the present invention, the controller may include a memory unit for storing data which associates the power generation output of the stack with a set value of the controlled target which does not cause occurrence of an unstable state of the power generation output of the stack at the power generation output; and a control unit configured to control the heat transmission medium supplier to cause the controlled target to have the set value, based on the data.

In such a configuration, the temperature of the stack can be lowered more properly when the power generation output is reduced.

In the polymer electrolyte fuel cell system according to the ninth invention of the present invention, the cathode gas channels may be formed such that a plurality of grooves extend in parallel and in a serpentine form from an inlet thereof to an outlet thereof and the grooves extending in parallel is reduced in number in a direction from the inlet to the outlet.

Since the anode gas and the cathode gas cause an electrochemical reaction to occur while flowing in the anode gas channels and the cathode gas channels, the anode gas and the cathode gas are reduced in amount in the anode gas channels and the cathode gas channels. Therefore, the speed of the anode gas and the speed of the cathode gas are reduced at a downstream region of the anode gas channels and at a downstream region of the cathode gas channels. However, in the above configuration, since the channel cross-sectional area of the anode gas channels and the cross-sectional area of the cathode gas channels are reduced at the downstream regions, reduction of the speed of the anode gas and the speed of the cathode gas can be suppressed. That is, the discharging of the condensed water from the anode gas channels and the cathode gas channels can be facilitated.

In the polymer electrolyte fuel cell system according to the tenth invention of the present invention, when the power generation output of the stack is reduced, the controller may control at least one of the anode gas supplier and the cathode gas supplier to increase a humidification amount of at least one of the anode gas and the cathode gas to increase a dew point temperature of at least one of the anode gas and the cathode gas. In such a configuration, the present invention can be carried out without the control for the temperature of the stack or without waiting the temperature control for the stack.

In the polymer electrolyte fuel cell system according to the eleventh invention of the present invention, before the controller controls at least one of the anode gas supplier, the cathode gas supplier, and the temperature control device to reduce the power generation output of the stack, the controller may set the dew point temperature of the gas supplied to at least one of the anode gas channels and the cathode gas channels to be higher than the temperature of the stack; and when the power generation output of the stack is reduced, the controller may cause the dew point temperature of the gas to be higher relative to the temperature of the stack so that the gas becomes supersaturated or more supersaturated than prior to causing the dew point temperature of the gas to be higher.

### EFFECTS OF THE INVENTION

As should be appreciated from the above, the PEFC system of the present invention provides an advantage that a power generation output can be made more stable even during a low power output state without making a structure of the PEFC system complex and without causing a possibility of an insufficient wet state of a polymer electrolyte membrane.

### BRIEF DESCRIPTION OF THE DRAWINGS

FIG. 1 is a view schematically showing a configuration of a PEFC system according to Embodiment 1 of the present invention.

FIG. 2 is a partially exploded perspective view showing a stack structure of a center portion of a stack of FIG. 1.

FIG. 3 is a plan view showing an inner surface of an anode separator plate used in the present embodiment.

FIG. 4 is a plan view showing an inner surface of a cathode separator plate used in the present embodiment.

FIG. 5 is a cross-sectional view of major components showing a structure of a cell of FIG. 2.

FIG. 6 is a partially exploded perspective view showing a stack structure of an end portion of the stack of FIG. 1.

FIG. 7 is a view schematically showing a configuration of a PEFC system according to Embodiment 2 of the present invention.

### EXPLANATION OF REFERENCE NUMERALS

1 polymer electrolyte membrane
2A anode catalyst layer
2C cathode catalyst layer
4A anode gas diffusion layer
4C cathode gas diffusion layer
5 membrane-electrode assembly (MEA)
6 gasket
7 MEA component
9A anode separator plate
9C cathode separator plate
10 cell
12I, 22I, 32I anode gas supply manifold hole
13I, 23I, 33I cathode gas supply manifold hole
12E, 22E, 32E anode gas discharge manifold hole
13E, 23E, 33E cathode gas discharge manifold hole
15 bolt hole
21 anode gas channel
31 cathode gas channel
31A grooves
31B bent portion
31C convex portion
40, 41 electric heat plate
40A, 41A terminal
50, 51 current collector
50A, 51A terminal portion
60, 61 insulating plate
70, 71 end plate
42I, 52I, 62I, 72I anode gas supply hole
42E, 52E, 62E, 72E anode gas discharge hole
43I, 53I, 63I, 73I cathode gas supply hole
43E, 53E, 63E, 73E cathode gas discharge hole
74I heat transmission medium supply hole
74E heat transmission medium discharge hole
82 fastener member
82B bolt
82W washer
82N nut
92I anode gas supply manifold
92E anode gas discharge manifold
93I cathode gas supply manifold
93E cathode gas discharge manifold
100, 200 stack
110 anode gas supplier
120 cathode gas supplier
130 electricity output system
140 heating electric circuit
140A variable resistor
150 heat transmission medium supplier
160 temperature meter
170 current meter
300 controller
301 input unit
302 memory unit
303 calculating unit
304 control unit

### BEST MODE FOR CARRYING OUT THE INVENTION

Hereinafter, best mode for carrying out the present invention will be described with reference to the drawings.

### Embodiment 1

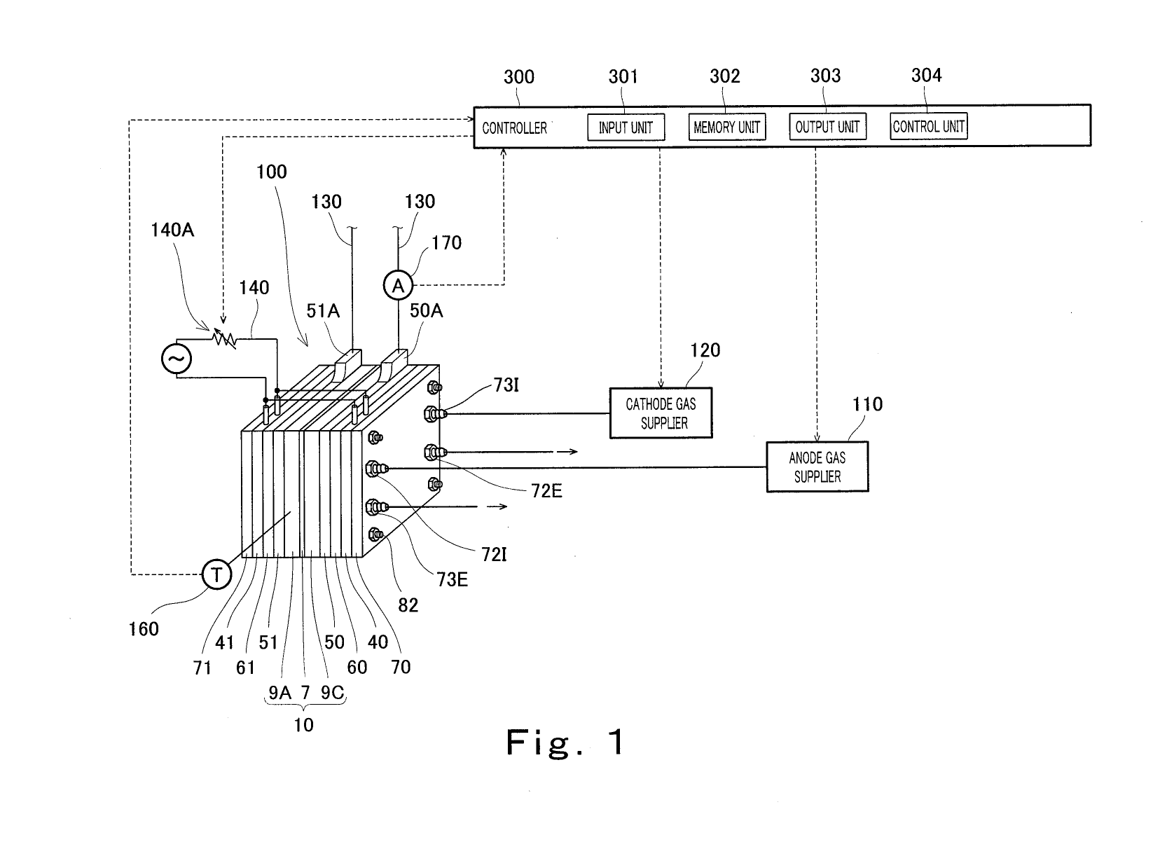

FIG. 1 is a view schematically showing a configuration of a PEFC system according to Embodiment 1 of the present invention.

As shown in FIG. 1, the PEFC system of present embodiment includes a cell 10 having an anode separator plate 9A, a cathode separator plate 9C and a MEA component 7 sandwiched between the anode separator plate 9A and the cathode separator plate 9C, a stack 100 including stacked cells, electric heat plates 40 and 41 for controlling the temperature of the stack 100, a heating electric circuit 140 for heating the electric heat plates 40 and 41, an anode gas supplier 110, a cathode gas supplier 120, and a controller 300 configured to control the heating electric circuit 140, the anode gas supplier 110 and the cathode gas supplier 120.

A temperature meter 160, the electric heat plates 40 and 41, and the heating electric circuit 140 form a temperature control device configured to control the temperature of the stack 100. The heating electric circuit 140 is configured to control a heating amount of the electric heat plates 40 and 41. In present embodiment, the heating electric circuit 140 includes an AC electric power supply and a variable resistor 140A. The variable resistor 140A enables the adjustment of the heating amount of the electric heat plates 40 and 41. The temperature meter 160 is configured to accurately detect the temperature in the interior of the stack 100. In present embodiment, the temperature meter 160 is configured such that a thermocouple is inserted into a hole formed in the anode separator 9A.

The anode gas supplier 110 is configured to supply an anode gas having a steam partial pressure to the stack 100. To be specific, the anode gas supplier 110 is configured to include a hydrogen tank and a humidifier, although not shown. A hydrogen gas is supplied from the hydrogen tank to an anode gas supply hole 72I of the stack 100 by way of the humidifier. Or, the anode gas supplier 110 is configured such that a reforming device having a reformer is coupled to the anode gas supply hole 72I of the stack 100. The reformer refers to a device configured to reform hydrocarbon such as a natural gas, GTL (Gas to liquid) fuel, or a DME (Dimethyl Ethel), into a hydrogen-containing gas through a steam reforming reaction. A shift converter for reducing a carbon monoxide concentration of the hydrogen-containing gas through a shift reaction and a selective oxidizer for reducing a carbon monoxide concentration of the hydrogen-containing gas through a selective oxidation reaction are coupled to the reforming device.

The cathode gas supplier 120 is configured to supply a cathode gas having a steam partial pressure to the stack 100. To be specific, the cathode gas supplier 120 is configured to supply air from an air blower such as a sirocco fan to a cathode gas supply hole 73I of the stack 100 by way of the humidifier, although not shown.

Terminal portions 50A and 51A are formed at current collectors 50 and 51, respectively. An electricity output system 130 is coupled to the terminal portions 50A and 51A. A current meter 170 is inserted into the electricity output system 130. The current meter 170 is capable of detecting an electricity output of the stack 130.

An output signal of the current meter 170 is sent to the controller 300.

The controller 300 includes an input unit 301 constituted by a key board, a touch panel, or the like, a memory unit 302 constituted by a memory or the like, an output unit 303 constituted by a monitor device, a printer, or the like, and a control unit 304 constituted by a CPU, a MPU, or the like. The controller 300 is configured to obtain a signal of the current meter 170 and to control the anode gas supplier 110 and the cathode gas supplier 120. That is, the controller 300 is configured to control the supply amount of the anode gas and the supply amount of the cathode gas according to the electricity output of the stack 100. Further, the controller 300 is configured to obtain temperature information measured by the temperature meter 160 and to control the variable resistor 140A in the heating electric circuit 140 so that the temperature of the stack 160 becomes a specified temperature.

As used herein, the term “controller” encompasses not only a single controller but also a controller group in which a plurality of controllers cooperate to execute control. Therefore, the controller 300 need not be constituted by a single controller but may be a plurality of controllers which are distributed and configured to cooperate with each other to control the anode gas supplier 110, the cathode gas supplier 120, and the variable resistor 140A. For example, the output unit 303 may be configured such that a mobile device displays information sent through an information terminal. The control unit 304 may be provided separately for each of the anode gas supplier 110 and the cathode gas supplier 120.

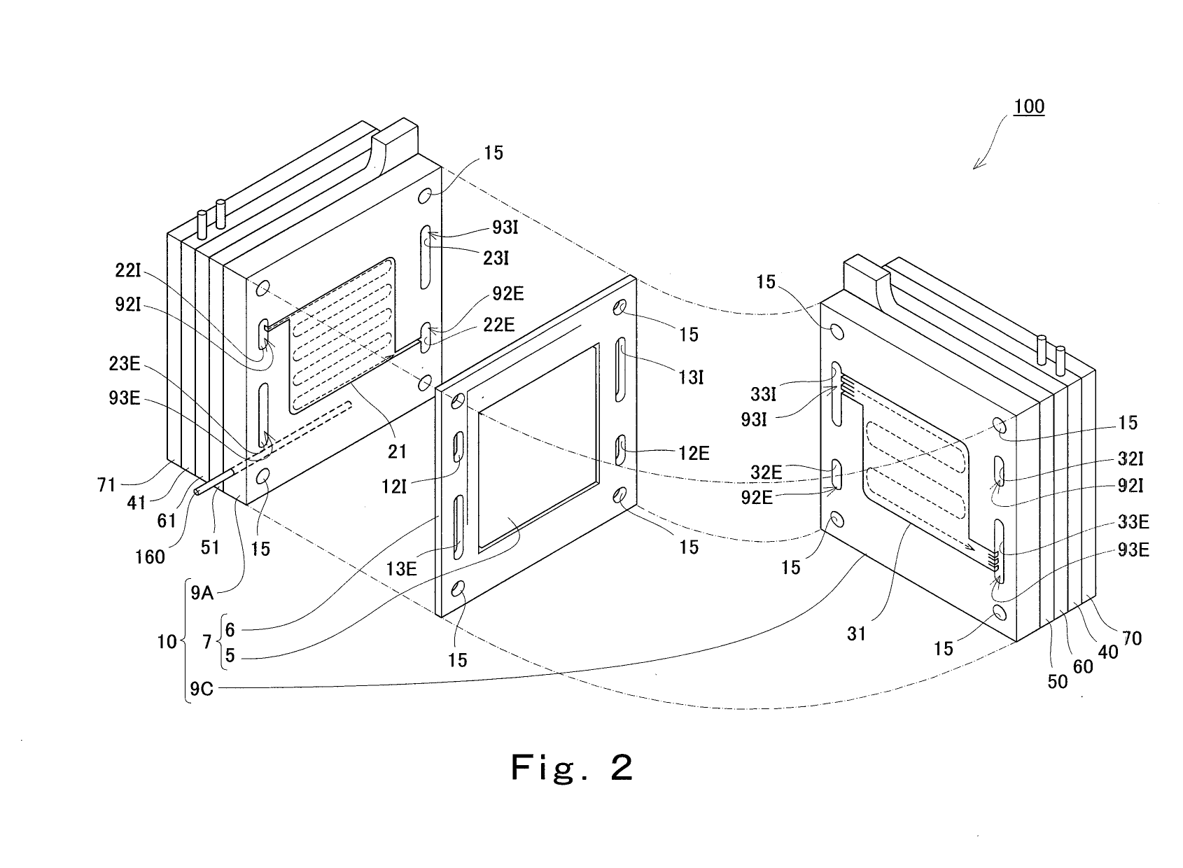

FIG. 2 is a partial exploded perspective view showing a stack structure of a center portion of the stack in FIG. 1. For the convenience of explanation, the fastener members such as the bolts 80 are omitted.

As shown in FIG. 2, the stack 100 has a rectangular parallellepiped shape and includes cells 100 formed in the center section thereof.

The cell 10 is configured to have the MEA component 7 sandwiched between a pair of anode separator plate 9A of a flat plate shape and the cathode separator plate 9C of a flat plate shape (both are correctively referred to as separator plates).

An anode gas supply manifold hole 12I, an anode gas discharge manifold hole 12E, a cathode gas supply manifold hole 13I, and a cathode gas discharge manifold hole 13E are formed to penetrate through a peripheral portion of the MEA component 7, an anode gas supply manifold hole 22I, an anode gas discharge manifold hole 22E, a cathode gas supply manifold hole 23I, and a cathode gas discharge manifold hole 23E are formed to penetrate through a peripheral portion of the separator plate 9A, and an anode gas supply manifold hole 32I, an anode gas discharge manifold hole 32E, a cathode gas supply manifold hole 33I, and a cathode gas discharge manifold hole 33E are formed to penetrate through a peripheral portion of the separator plate 9C. The anode gas supply manifold holes 12I, 22I, and 32I are connected in the stack 100 to form the anode gas supply manifold 92I and the anode gas discharge manifold holes 12E, 22E, and 32E are connected in the stack 100 to form the anode gas discharge manifold 92E. In the same manner, the cathode gas supply manifold holes 13I, 23I, and 33I, are connected in the stack 100 to form the cathode gas supply manifold 93I, and the cathode gas discharge manifold holes 13E, 23E, and 33E are connected in the stack 100 to form the cathode gas discharge manifold 93E.

The MEA component 7 is sandwiched between an inner surface of the separator plate 9A and an inner surface of the separator plate 9C and center regions of the inner surfaces of the separator plates 9A and 9C are in contact with the MEA 5. The separator plates 9A and 9C are made of an electrically conductive material. The separator plates 9A and 9C are each formed of a compression-molded separator plate manufactured by compression-molding of a mixture of electrically conductive carbon and binder. With such a configuration, in the cell 10, electric energy generated in the MEA 5 can be taken to outside through the separator plates 9A and 9C.

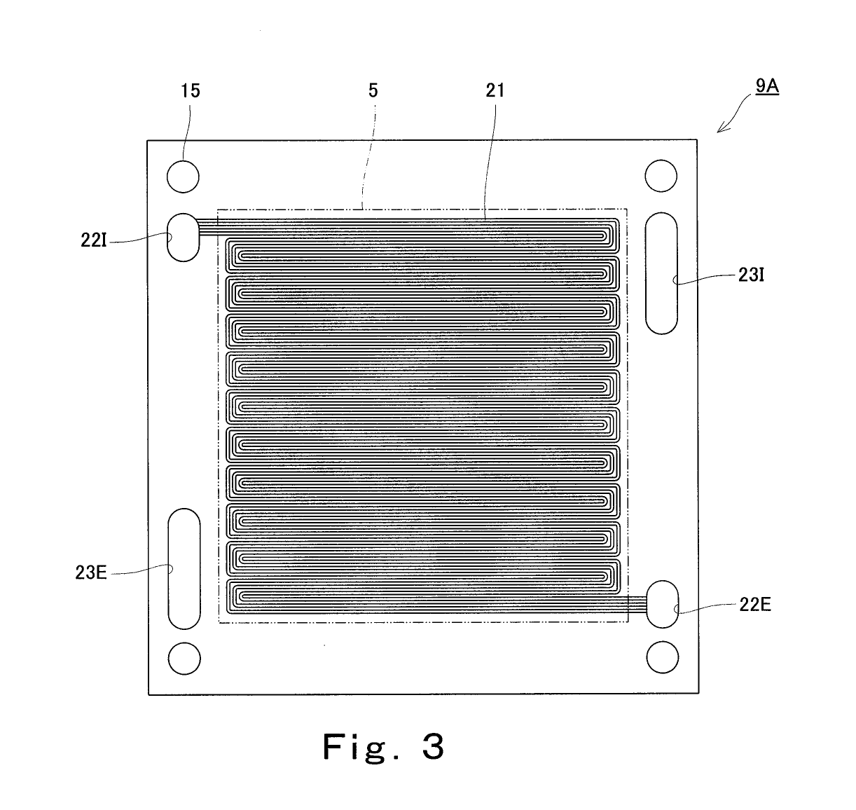

FIG. 3 is a plan view showing the inner surface of the anode separator plate used in present embodiment.

As shown in FIG. 3, anode gas channels 21 are formed on the inner surface of the anode separator plate 9A such that the anode gas channels 21 serpentine over the entire region which is in contact with the MEA 5 of the MEA component 7 and connect the anode gas supply manifold hole 22I to the anode gas discharge manifold hole 22E. The anode gas channels 21 include three grooves formed to extend in parallel.

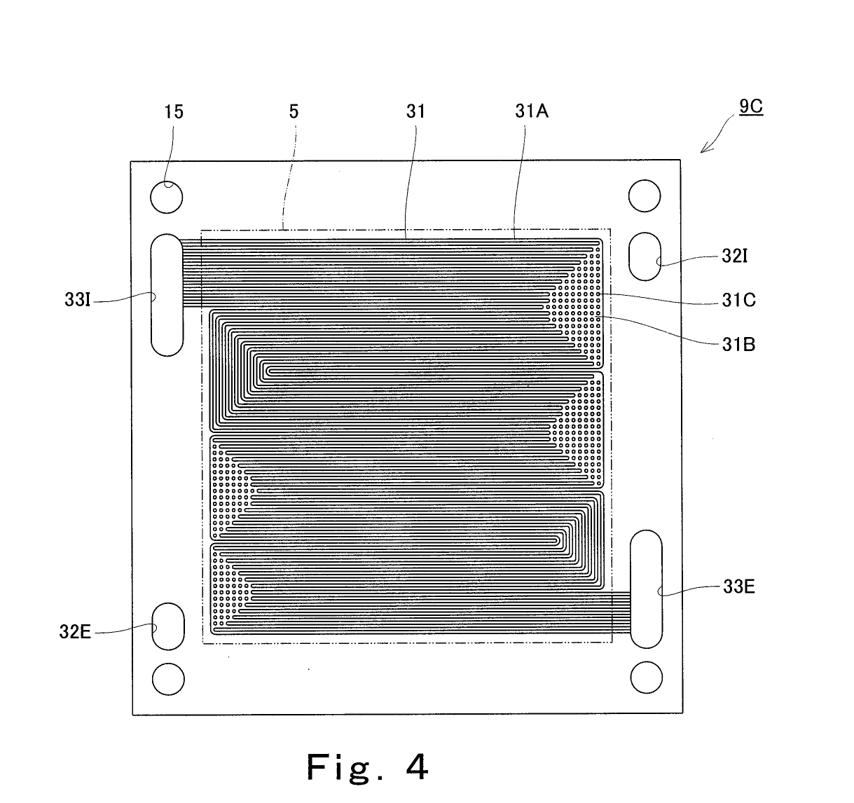

FIG. 4 is a plan view showing the inner surface of the cathode separator plate used in present embodiment.

As shown in FIG. 4, cathode gas channels 31 are formed on the inner surface of the cathode separator plate 9C such that the cathode gas channels 31 serpentine over the entire region which is in contact with the other main surface of the MEA 5 of the MEA component 7 and connect the cathode gas supply manifold hole (inlet) 33I to the anode gas discharge manifold hole (outlet) 33E. The cathode gas channels 31 are formed such that eleven grooves 31A extend in parallel and in a serpentine form and the number of the grooves 31A extending in parallel is reduced in a direction from the cathode gas supply manifold hole (inlet) 33I toward the cathode gas discharge manifold hole (outlet) 33E. In present embodiment, a plurality of bent portions 31B are formed, at which the cathode gas channels 31 invert their extending directions. A part of the bent portions 31B are formed by recesses of a substantially triangular shape. A number of convex portions 31C are arranged in matrix in the recesses. The downstream ends of the grooves 31A located upstream of each recess are connected to the recess, while the upstream ends of the grooves 31A located downstream of the recess are connected to the recess. Therefore, the cathode gas travels along the plurality of convex portions 31C in the bent portion 31B. The bent portion 31B allows the cathode gas to be agitated. The convex portions 31C support the MEA 5. The grooves 31A are formed at downstream side of the bent portion 31B in the direction in which the cathode gas travels. But, the number of grooves 31A is reduced by one and is ten. Therefore, the channel cross-sectional area of the cathode gas channels 31 is made smaller at downstream side of the bent portion 31B than at the upstream side thereof. In contrast, the cathode gas flowing in the grooves 31A is consumed through an electrochemical reaction and thereby reduced in amount. This suppresses reduction of the speed of the cathode gas flowing in the grooves 31A, facilitating discharging of condensed water from the grooves 31A.

In addition, the channel cross-sectional area of the cathode gas channels 31 is made smaller at downstream side of the plurality of bent portions 31B than at the upstream side thereof, and thus, the channel cross-sectional area of the cathode gas channels 31 is reduced in a stepwise manner as the cathode gas flowing in the cathode gas channels 31 is reduced in amount. This enables further stabilization of the speed of the cathode gas flowing from the cathode gas supply manifold hole (inlet) 33I to the cathode gas discharge manifold hole (outlet) 33E, facilitating discharging of the condensed water from the cathode gas channels 31.

Now, the characteristic of the surfaces of the anode separator channels 21 and the cathode separator channels 31 (hereinafter collectively referred to as “channels 21 and 31) will be described.

The surfaces of the channels 21 and 31 have a highly hydrophilic property, rather than a water-repellent property. To be specific, the hydrophilic property of the surface is suitable when the contact angle of the surface is 90 degrees or smaller. As used herein, the term “contact angle” refers to an angle (internal angle of the water droplet) formed between a liquid surface and the surface of the channel at a location where a free surface of the water droplet is in contact with the surface of the channel (see page 690 of fourth edition of Iwanami Rikagaku Jiten). More specifically, the “contact angle” refers to an angle formed between a horizontally oriented surface of the channel and the liquid surface of a specified amount of the water droplet placed in stationary state on the surface of the channel.

In present embodiment, the channels 21 and 31 have surfaces subjected to hydrophilic property improvement treatment. The hydrophilic property improvement treatment refers to a treatment performed for increasing minute concave-convex regions (i.e., specific surface area) or polarities on the surface of the channel to enable the surface of the channel to have a hydrophilic property. As examples of known techniques of the hydrophilic property improvement treatment, there are an etching process, a blasting process, a polishing process, a glow discharge process, and an oxygen plasma process.

In present embodiment, the channels 21 and 31 have surfaces subjected to oxygen plasma treatment. To be specific, the channels 21 and 31 have surfaces subjected to the oxygen plasma treatment performed by a plasma cleaning apparatus (PC-1000 manufactured by SAMCO Co., ltd.). The inventors presume that the oxygen plasma treatment can increase hydrophilic functional groups on the surfaces of the channels 21 and 31 and thereby increase the polarities thereof, making the surfaces of the channels 21 and 31 have a hydrophilic property. Therefore, it is easily presumed that a method of chemically coupling the hydrophilic functional groups to the surfaces of the channels 21 and 31, such as the glow discharge process, can improve the contact angle of the surfaces of the channels 21 and 31. Further, the etching process, the blasting process, and the polishing process are capable of forming numerous minute concave-convex regions on the surfaces of the channels 21 and 31 so that the hydrophilic property of the channels 21 and 31 is improved.

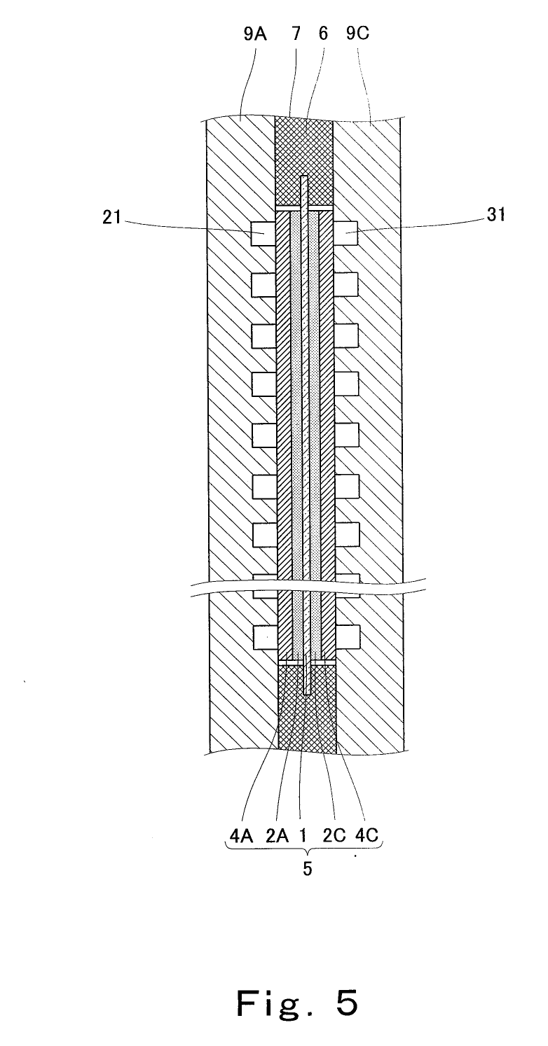

FIG. 5 is a cross-sectional view of major components, showing a structure of the cell of FIG. 2.

The MEA 5 includes a polymer electrolyte membrane 1 formed by an ion exchange membrane which allows selective permeation of hydrogen ions, a pair of anode catalyst layer 2A and cathode catalyst layer 2C which are formed by carbon powder carrying platinum metal catalyst as a major component and sandwich the polymer electrolyte membrane, and a pair of anode gas diffusion layer 4A and cathode gas diffusion layer 4C which are respectively provided on the outer surfaces of the pair of catalyst layers 2A and 2C. The catalyst layers 2A and 2C and the gas diffusion layers 4A and 4C form electrodes. To be specific, the MEA 5 is configured to include the polymer electrolyte membrane 1 and a pair of electrodes respectively stacked on center regions of both main surfaces of the polymer electrolyte membrane 1. The electrode surfaces are formed on the both main surfaces of the MEA 5.

As the polymer electrolyte membrane 1, a membrane made of perfluorosulfonic acid is suitable. For example, the polymer electrolyte membrane 1 may be Nafion (registered trademark) membrane produced by DuPont Co., ltd. The MEA 5 is typically manufactured by sequentially applying the catalyst layers 2A and 2C and the gas diffusion layers 4A and 4C onto the polymer electrolyte membrane, transfer printing and hot pressing of them, etc. Or, a commercially available product MEA 5 thus manufactured may be used. Typically, the catalyst layers 2A and 2C are molded to have a thickness of about 10 to 20 μm. The gas diffusion layers 4A and 4C are manufactured by applying a paint onto a base which is carbon woven cloth. The gas diffusion layers 4A and 4C have a porous structure having gas-permeability and electron conductivity. The gas diffusion layers 4A and 4C and the catalyst layers 2A and 2B are joined to the both surfaces of the center portion of the polymer electrolyte membrane 1, thereby manufacturing the MEA 5.

The MEA component 7 has a structure in which a portion of the polymer electrolyte membrane 1 extending in a peripheral portion of the MEA 5 is sandwiched between a pair of gaskets 6. Therefore, the MEA 5 is exposed on both surfaces of openings in the center portions of the gaskets 6. The gaskets 6 are made of an elastic material having resistance to environment. For example, a suitable material for the gaskets 16 is fluorine-based rubber. The anode gas supply manifold hole 12I, the anode gas discharge manifold hole 12E, the cathode gas supply manifold hole 13I, and the cathode gas discharge manifold hole 13E are formed on the peripheral portion of the MEA component 7 to penetrate through the gaskets 6.

The MEA 5 of the MEA component 7 serves as a lid for the anode gas channels 21 and the cathode gas channels 31. To be specific, the anode gas channels 21 of the anode separator 9A are in contact with the anode gas diffusion layer 4A. Thereby, without leakage to outside, the anode gas flowing within the anode gas channels 21 enters the inside of the porous anode gas diffusion layer 4A while being diffused and reaches the anode catalyst layer 2A. In the same manner, the cathode gas channels 31 of the cathode separator 19C are in contact with the cathode gas diffusion layer 4C. Thereby, without leakage to outside, the cathode gas flowing within the cathode gas channels 31 enters the inside of the porous cathode gas diffusion layer 4C while being diffused and reaches the cathode catalyst layer 2C. Thereby, the cell reaction can occur.

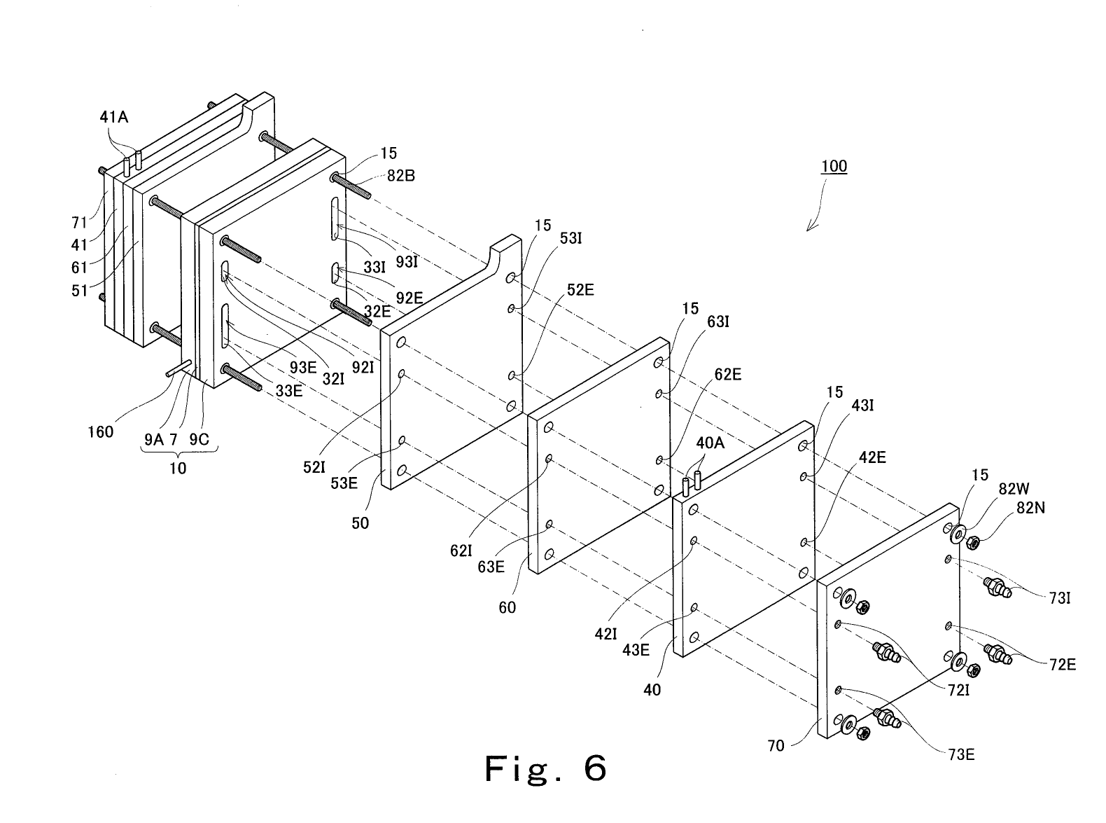

FIG. 6 is a partially exploded perspective view showing a stack structure of an end portion of the stack in FIG. 1.

A stack 100 has a structure in which a pair of end members are stacked on both sides of the cell 10. To be specific, on both sides of the cell 10, current collectors 50 and 51, insulating plates 60 and 61, electric heat plates 40 and 41, and end plates 70 and 71 which have flat surfaces of the same shape as that of the separator plates) 9A and 9C are stacked. At four corners of the current collectors 50 and 51, the insulating plates 60 and 61, the electric heat plates 40 and 41, and the end plates 70 and 71, bolt holes 15 are formed to be connected to bolt holes of the cells 10.

The current collectors 50 and 51 are made of electrically conductive material such as copper metal.

The insulating plates 60 and 61 and the end plates 70 and 71 are made of electrically insulating material.

The electric heat plates 40 and 41 include inside thereof heat emitters for emitting heat by electric resistances and a pair of terminals 40A and 41A which are electrically conductive with the heat emitters.

A plurality of through holes are formed on the current collector 50, the insulating plate 60, the electric heat plate 40, and the end plate 70 to penetrate therethrough in the thickness direction and to be connected to each other. To be specific, the anode gas supply holes 52I, 62I, 421, and 72I connected to the anode gas supply manifold 92I, the anode gas discharge holes 52E, 62E, 42E, and 72E connected to the anode gas discharge manifold 92E, the cathode gas supply holes 53I, 63I, 43I, and 73I connected to the cathode gas supply manifold 93I, and the cathode gas discharge holes 53E, 63E, 43E, and 73E connected to the cathode gas discharge manifold 93E are formed.

Nozzles are attached to the anode gas supply hole 72I, the anode gas discharge hole 72E, the cathode gas supply hole 73I, and the cathode gas discharge hole 73E on the outer surface side of the end pate 70, respectively. As these nozzles, general connecting members connected with outside pipe members are used.

Although not shown, the current collector 51, the insulating plate 61, the electric heat plate 41 and the end plate 71 have the same structures as those of the current collector 50, the insulating plate 60, the electric heat plate 40 and the end plate 70, except that no through holes are formed in the current collector 51, the insulating plate 61, the electric heat plate 41 and the end plate 71. In this structure, inside the stack 100, the anode gas passage is formed in such a manner that it extends through the anode gas supply holes 52I, 62I, and 72I and the anode gas supply manifold 92I, branches into the anode gas channels 21, gather at the anode gas discharge manifold 92E, and reach the anode gas discharge holes 52E, 62E, and 72E. Inside the stack 100, the cathode gas passage is formed in such a manner that it extends through the cathode gas supply holes 53I, 63I, and 73I and the cathode gas supply manifold 93I, branches into the cathode gas channels 31, gather at the cathode gas discharge manifold 93E, and reach the cathode gas discharge holes 53E, 63E, and 73E.

The members between the pair of end plates 70 and 71 are fastened by fastener members 82. In present embodiment, bolts 82B are inserted into the bolt holes 15 to penetrate through the members between both ends of the stack 100. A washer 82W and a nut 82N are attached to each of the both ends of the bolt 82B to fasten the members between the pair of end plates 70 and 71. For example, they are fastened by a force of about 10 kgf/cm² per area of the separators.

Subsequently, the operation of the PEFC system of present embodiment will be described with reference to FIG. 1.

The operation is executed under control of the controller 300.

During a rated power output state where a stable power generation output is obtained (hereinafter referred to as “during rated power output state”), the anode gas supplier 110 humidifies the anode gas up to a dew point of 70° C. and supplies to the stack 100 the humidified anode gas under the state of about 70° C. That is, the anode gas which is water-saturated is supplied to the stack 100.

In the same manner, the cathode gas supplier 120 humidifies the cathode gas up to a dew point of 70° C. and supplies the humidified cathode gas to the stack 100 under the state of about 70° C. That is, the cathode gas which is water-saturated is supplied to the stack 100.

Further, the variable resistor 140A of the heating electric circuit 140 is controlled so that the temperature measured by the temperature meter 160 becomes about 70° C. That is, the PEFC system is operated under the state where the anode gas and the cathode gas are substantially water-saturated inside the stack 100. Alternatively, as disclosed in patent document 1, the temperature measured by the temperature meter 160 is about 1 to 3° C. lower than the dew point temperature. This makes it possible to keep the entire region of the MEA 5 in a water-saturated state more surely.

When the power generation output is reduced to a low power output which corresponds to about 30% of the rated power output, the anode gas supplier 110 humidifies the anode gas up to a dew point of 70° C. and supplies the humidified anode gas to the stack 100 under the state of about 70° C. That is, as in the rated power output state, the anode gas in the water-saturated state is supplied to the stack 100. Nonetheless, the anode gas supplier 110 reduces a supply amount of the anode gas so that oxygen utilization rate is substantially equal to that during the rated power output state.

In the same manner, during the low power output state, the cathode gas supplier 120 humidifies the cathode gas up to a dew point of 70° C. and supplies the humidified cathode gas to the stack 100 under the state of about 70° C. That is, as in the rated power output state, the cathode gas which is water-saturated is supplied to the stack 100. But, the cathode gas supplier 120 reduces a supply amount of the cathode gas so that oxygen utilization rate is substantially equal to that during the rated power output state.

Furthermore, during the low power output state, the variable resistor 140A of the heating electric circuit 140 is controlled so that the temperature measured by the temperature meter 160 is lower than the temperature during the rated power output state. That is, the variable resistor 140A is controlled so that the dew point temperatures of the gasses supplied to the channels 21 and 31 are higher relative to the temperature of the stack 100. To be specific, the temperature is suitably 5 to 10° C. lower than the temperature during the rated power output state. That is, the PEFC system is configured to reduce the supply amount of the anode gas and the supply amount of the cathode gas and to set the dew point temperatures of the gases supplied to the channels 21 and 31 to be higher relative to the temperature of the stack 100 so that the gases supplied to the channels 21 and 31 are supersaturated or more supersaturated than prior to causing the dew point temperature of the gas to be higher. This can stabilize the power generation output during the low power output state.

Specific examples of present embodiment will be described.

### Example 1

In the PEFC system according to Embodiment 1 of the present invention, graphite plates impregnated with phenol resin were used as the separator plates 9A and 9C. The separator plates 9A and 9C have a planar shape of about 150 mm square and a thickness of about 3 mm.

The anode gas channels 21 and the cathode gas channels 31 were formed by cutting process. The oxygen plasma treatment was conducted on the surfaces of the anode gas channels 21 and the cathode gas channels 31 such that the contact angle of water is 10 degrees.

As the MEA 5, a commercially available product, “PRIMEA (product name)” manufactured by Japan Gore Tex Co., ltd was used.

The PEFC system was operated at a constant voltage. The current density of power generation during the rated power output state was 0.2 A/cm², while the current density of power generation during the low power output state (30% output state) was 0.06 A/cm².

The anode gas supplier 110 controlled the anode gas flow rate so that oxygen utilization rate became about 75% during the rated power output state and the low power output state.

The cathode gas supplier 120 controlled the cathode gas flow rate so that fuel utilization rate became about 95% during the rated power output state and the low power output state.

The anode gas and the cathode gas were humidified and heated to have dew point temperatures of 66° C. and supplied to the stack 100.

During the rated power output state, the temperature of the stack 100 was heated up to 66° C. by the electric heat plates 40 and 41.

During the low power output state, the temperature of the stack 100 was heated up to 58° C. by the electric heat plates 40 and 41.

In this example, during the rated power output state and the low power output state, the PEFC system was able to continue the power generation output stably.

### Comparative Example 1

As comparative example of Example 1, the PEFC system used in example 1 was operated under the condition in which the temperature of the stack 100 during the low power output state was 66° C., i.e., the anode gas and the cathode gas were water-saturated inside the stack 100. However, the power generation voltage of the PEFC system decreased to 0 mV (lower than a measurement limit) and thus, the power generation was impossible.

For the events of Example 1 and Comparative example 1, a water discharge structure of the channels 21 and 31 are presumed as follows. To be specific, since the speed of the anode gas and the speed of the cathode gas flowing in the channels 21 and 31 are sufficient during the rated power output state, the PEFC system was able to operate stably regardless of whether the anode gas and the cathode gas were water-saturated or water-oversaturated inside the stack 100, during the rated power output state. However, since the flow speed of the anode gas and the flow speed of the cathode gas are reduced during the low power output state, the condensed water is stagnant on the surfaces of the channels 21 and 31 as water droplets. Because of deteriorated water discharge ability, the power generation output of the PEFC system becomes unstable, and the PEFC system was unable to generate electric power in serious cases. By setting the temperature of the stack 100 to 58° C., the anode gas and the cathode gas become water-supersaturated or more water-supersaturated in the channels 21 and 31 than prior to setting the stack temperature to 58° C. As a result, a water film is formed on the surfaces of the channels 21 and 31 substantially continuously from the supply manifold holes (inlets) 22I and 33I to the discharge manifold holes (outlets) 22E and 33E. The condensed water on the surfaces of the channels 21 and 31 is taken into the water film and is easily pushed to the outlets while flowing on the water film. Such a water discharge structure can improve the water discharge ability of the channels 21 and 31 and suppress clogging of the channels 21 and 31 with the condensed water, enabling the PEFC system to stabilize the power generation output during the low power output state.

### Embodiment 2

A stack 200 according to Embodiment 2 of the present invention includes a plurality of cells 10 which are stacked. The structure of a temperature control device of the PEFC system is different from that of Embodiment 1. To be specific, in Embodiment 2, the electric heat plates 40 and 41 and the heating electric circuit 140 in Embodiment 1 are omitted, and a heat transmission medium supplier 150 is provided. Therefore, different components or members of the PEFC system will be described, whereas the other components and members are the same as those in Embodiment 1 and will not be described.

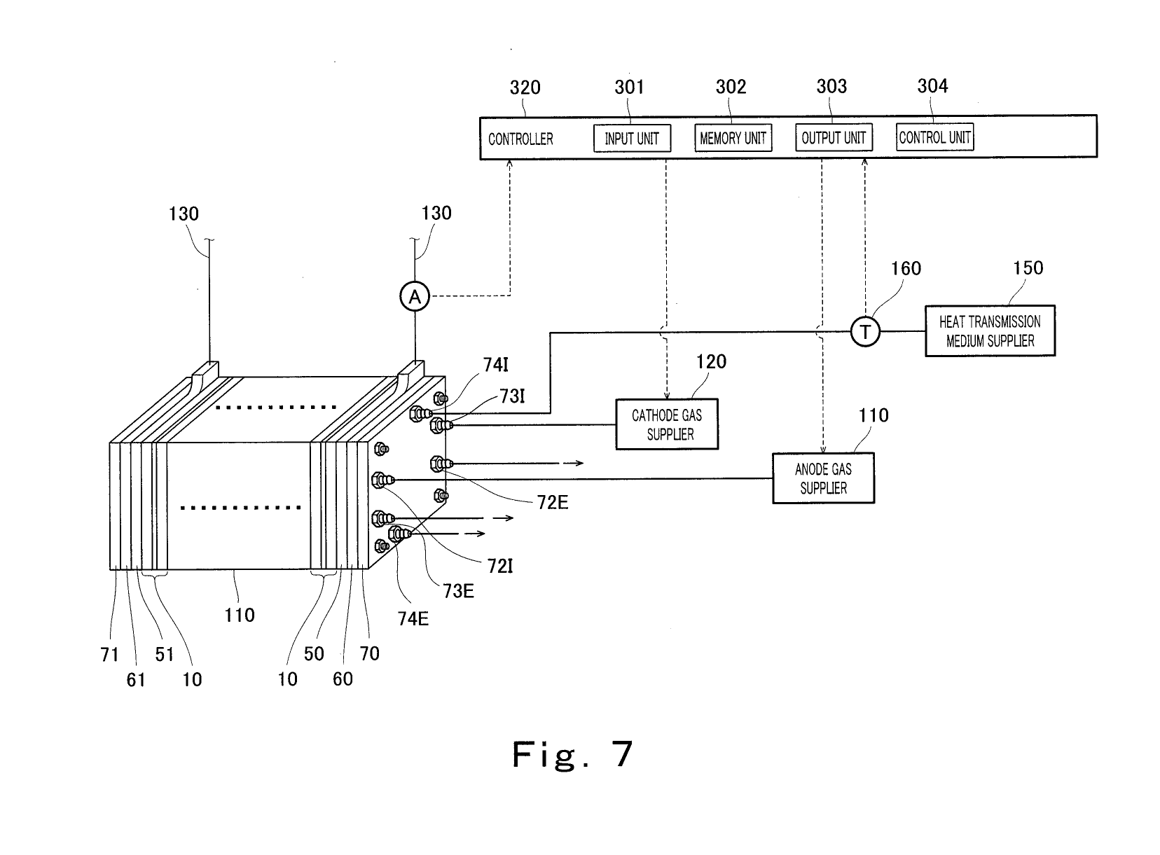

FIG. 7 is a view schematically showing a configuration of the PEFC system according to Embodiment 2 of the present invention.

As shown in FIG. 7, in Embodiment 2, the electric plates 40 and 41 and the heating electric circuit 140 in Embodiment 1 are omitted, while the heat transmission medium supplier 150 is provided.

The heat transmission medium supplier 150 is configured to supply a heat transmission medium to the stack 200 and is configured to control the temperature of the heat transmission medium. In present embodiment, a temperature meter 160 is provided on a passage extending from the heat transmission medium supplier 150 to a heat transmission medium supply hole 74I of the stack, i.e., a passage at an outlet side of the heat transmission medium. Alternatively, the temperature meter 160 may be provided on a passage provided at an outlet side of the heat transmission medium, i.e., a passage extending from the heat transmission medium discharge hole 74E. This makes it possible to control the temperature of the stack 200 according to the temperature of the heat transmission medium.

Typically, the heat transmission medium supplier 150 includes a pump for driving a heat transmission medium and a heat exchanger capable of heating and cooling the heat transmission medium.

As the heat transmission medium, water is typically used. However, the heat transmission medium is not limited to the water so long as the heat transmission medium is excellent in chemical stability, fluidity, and heat transmissivity. For example, the heat transmission medium may be silicon oil.

The heat transmission medium supplier 150 may be configured to control the temperature of the stack 200. Therefore, the heat transmission medium supplier 150 may be configured to control the flow rate of the heat transmission medium. In this case, the temperature meter 160 may be inserted into the stack 200 as in Embodiment 1. Alternatively, the temperature meter 160 may be disposed on the passage provided at the outlet side of the heat transmission medium, i.e., the passage extending from the heat transmission medium discharge hole 74E.

A heat transmission medium supply manifold, a heat transmission medium discharge manifold, and a heat transmission medium passage are formed inside the stack 200, although not shown. The heat transmission medium passage extends between the surfaces of the stacked cells 10 so as to connect the inlet and outlet of the heat transmission medium. The heat transmission medium supply manifold and the heat transmission medium discharge manifold are formed to penetrate through the cells 10 in the direction in which the cells 10 are stacked. These structures are shown in, for example, FIG. 2 of patent document 3 and FIG. 14 of patent document 5.

Heat transmission medium supply holes 74I and heat transmission medium discharge holes 74E are formed on the end plate 70, the insulating plate 60 and the current collector 50 of the stack 200 such that the heat transmission medium supply holes 74I are connected to each other and the heat transmission medium discharge holes 74E are connected to each other. To be specific, the cooling medium supplied from the heat transmission medium supplier 150 to the heat transmission medium supply hole 74I flows through the heat transmission medium supply manifold and flows so as to branch into the heat transmission medium passages between the cells 10. The heat transmission medium which has flowed in the heat transmission medium passages gathers at the heat transmission medium discharge manifold and is discharged from the heat transmission medium discharge hole 74E to outside.

With such a configuration, the temperature of the stack 200 can be controlled by controlling the temperature of the heat transmission medium supplied from the heat transmission medium supplier 150 based on the temperature measured by the temperature meter 160.

To be specific, the heat transmission medium is supplied at 66° C., and is discharged from the stack 200 at 71° C. The anode gas and the cathode gas are each humidified and heated up to a temperature of 71° C. and up to a dew point temperature of 71° C. and supplied to the stack 200. During the low power output state, the heat transmission medium supplier 150 is controlled so that the temperature measured by the temperature meter 160 is lower than the temperature during the rated power output state. To be specific, the temperature is suitably about 5° C. to 10° C. lower than the temperature during the rated power output state. On the other hand, the anode gas and the cathode gas are each humidified and heated up to the dew point temperature at the time of the rated power output state and supplied to the stack 200. That is, during the low power output state, the PEFC system makes the anode gas and the cathode gas water-supersaturated or more water-supersaturated in the channels 21 and 31 than prior to heating the gas. This makes it possible to stabilize the power generation output during the low power output state, as in Embodiment 1.

Alternatively, the PEFC system may be configured to substantially automatically set the supply amount of the anode gas, the supply amount of the cathode gas, and the temperature of the stack 100 according to reduction of the power generation output. For each of the plurality of power generation outputs, the supply amount of the anode gas, the supply amount of the cathode gas, and the heat transmission medium temperature (controlled target) which will not cause occurrence of an unstable state of the power generation output are obtained in advance from an operation test. A data base containing the anode gas supply amount, the cathode gas supply amount, the corresponding set values, and the set values of the power generation output are entered with the input unit 301 and stored in the memory unit 302. The controller 300 may be configured to control the anode gas supplier 110, the cathode gas supplier 120 and the heat transmission medium supplier 150 so that the anode gas supply amount, the cathode gas supply amount and the heat transmission medium temperature become the corresponding set values based on the data base and according to reduction of the power generation output. In such a configuration, the temperature of the stack 200 may be reduced more properly according to reduction of the power generation output.

Thus far, the embodiments of the present invention have been described in detail. However, the present invention is not limited to the above embodiments.

In the above embodiments, the anode gas channels 21 and the cathode gas channels 31 have surfaces subjected to the hydrophilic property improvement treatment. However, the advantage of the present invention is achieved even in the case where these channels do not have the surfaces subjected to the hydrophilic property improvement treatment. That is, the surfaces of the anode gas channels 21 and the cathode gas channels 31 need not have highly hydrophilic property.

In the above embodiments, during the low power output state, the gases supplied to both of the anode gas channels and the cathode gas channels are water-supersaturated or more water-supersaturated and caused to have dew point temperatures higher relative to the temperature of the stack 100 or the stack 200 than prior to causing the dew point temperature to become higher. However, during the low power output state, the gases supplied to both of the anode gas channels and the cathode gas channels need not be water-supersaturated or more water-supersaturated. That is, the dew point temperature of the gas supplied to at least either one of the anode gas channels and the cathode gas channels may be made higher relative to the temperature of the stack 100 or 200 so that the gas supplied to at least either one of the anode gas channels and the cathode gas channels is water-supersaturated or more water-supersaturated than prior to raising the dew point temperature of the gas.

The present invention may be carried out by controlling at least one of the anode gas supplier 110, the cathode gas supplier 120, and the temperature control device (variable resistor 140A of Embodiment 1, and the heat transmission medium supplier 150 of Embodiment 2). For example, during the low power output state, the supply amount of the anode gas and the supply amount of the cathode gas are made smaller than those during the rated power output state, and at least one of the anode gas supplier 110, the cathode gas supplier 120, and the temperature control device (variable resistor 140A of Embodiment 1, and the heat transmission medium supplier 150 of Embodiment 2) is controlled so that the dew point temperatures of the gases supplied to the anode gas channels 21 and the cathode gas channels 31 are higher relative to the temperature of the stack 100.

For example, during the low power output state, the anode gas supplier 110 may increase the humidification amount to increase the dew point temperature of the anode gas and supply the anode gas to the stack 100 or 200. Thereby, the present invention can be carried out without controlling the temperature of the stack 100 or 200, or without waiting the temperature control for the stack 100 or 200.

In this case, since the dew point temperature of the anode gas is higher relative to the temperature of the stack 100 or 200, the anode gas is water-supersaturated or more water-supersaturated in the anode gas channels 21. To be specific, in Embodiment 2, a heat transmission exchange type humidifying device using a water-permeable membrane is used as the anode gas supplier 110. The heat transmission exchange type humidifying device heats the anode gas in a water-saturated state. Therefore, the anode gas is supplied to the stack 200 under the saturated state, i.e., under the state where the supply temperature is substantially equal to the dew point temperature. In a case where the supply temperature of the anode gas is 66° C., i.e., the dew point temperature thereof is 66° C., and the heat transmission medium is discharged at 71° C. during the rated power output state, the supply temperature of the anode gas may be increased up to 71° C., i.e., the dew point temperature may be increased up to 71° C. during the low power output state. This can increase the humidification amount of the anode gas.

By the way, in an earlier stage of the present invention, the inventors found a method of increasing the humidification amount of the anode gas and the humidification amount of the cathode gas by controlling the anode gas supplier 110 and the cathode gas supplier 120.

However, the inventors considered that, in such a configuration, since it is necessary to control the dew point temperature of the anode gas in the anode gas supplier 110 and the dew point temperature of the cathode gas in the cathode gas supplier 120, the control in the PEFC system becomes somewhat complex, affecting economic efficiency of the present invention.

Accordingly, the inventors intensively studied the method of carrying out the present invention more economically, and conceived Embodiment 1 and Embodiment 2. That is, the inventors found that the anode gas and the cathode gas become water-supersaturated or more water-supersaturated by lowering the temperature of the stack 100 or 200. This conception can eliminate the control for the dew point temperature of the anode gas in the anode gas supplier 110 and the control for the dew point temperature of the cathode gas in the cathode gas supplier 120 in the present invention. In other words, the conception can omit the control for the factors other than the supply amount in the anode gas supplier 110 and the supply amount in the cathode gas supplier 120. As a result, the present invention can be carried out more easily.

### INDUSTRIAL APPLICABILITY

The present invention is useful as a PEFC system which is capable of stabilizing a power generation output even during a low power output state without making the structure of the PEFC system complex and without causing a possibility of insufficient wet state of the polymer electrolyte membrane.

1. A polymer electrolyte fuel cell system comprising:
cells each including an anode separator plate provided with anode gas channels, a cathode separator plate provided with cathode gas channels, and a MEA sandwiched between the anode separator plate and the cathode separator plate;
a stack including the cells stacked;
a temperature control device for controlling a temperature of the stack;
an anode gas supplier to supply an anode gas having a steam partial pressure to the anode gas channels;
a cathode gas supplier to supply a cathode gas having a steam partial pressure to the cathode gas channels; and
a controller configured to control the temperature control device, the anode gas supplier, and the cathode gas supplier;
wherein when a power generation output of the stack is reduced, the controller controls the anode gas supplier and the cathode gas supplier to reduce a supply amount of the anode gas and a supply amount of the cathode gas, and controls at least one of the anode gas supplier, the cathode gas supplier, and the temperature control device to cause a dew point temperature of a gas supplied to at least one of the anode gas channels and the cathode gas channels to be higher relative to the temperature of the stack so that said gas becomes supersaturated or more supersaturated than prior to causing the dew point temperature of said gas to be higher.

2. The fuel cell system according to claim 1, wherein at least one of the anode gas channels and the cathode gas channels has a surface having a contact angle of 90 degrees or smaller.

3. The polymer electrolyte fuel cell system according to claim 1, wherein at least one of the anode separator plate and the cathode separator plate is a compression-molded separator plate manufactured by compression-molding of a mixture containing electrically conductive carbon and binder; and wherein
at least one of the anode gas channels and the cathode gas channels formed on the compression-molded separator plate has a surface subjected to a hydrophilic property improvement treatment.

4. The polymer electrolyte fuel cell system according to claim 3, wherein
the hydrophilic property improvement treatment is an oxygen plasma treatment.

5. The polymer electrolyte fuel cell system according to claim 1, wherein
the controller controls the temperature control device to lower the temperature of the stack, when the power generation output of the stack is reduced.

6. The polymer electrolyte fuel cell system according to claim 5, wherein
the stack has heat transmission medium passages each of which is formed between surfaces of the cells stacked;
wherein the temperature control device is a heat transmission medium supplier configured to supply the heat transmission medium to the heat transmission medium supply passage and to control at least one of a temperature and a flow rate of the heat transmission medium which is a controlled target; and
wherein the controller controls the controlled target to lower the temperature of the stack, when the power generation output of the stack is reduced.

7. The polymer electrolyte fuel cell system according to claim 6, wherein
the heat transmission medium supplier is configured to control a temperature of the heat transmission medium; and wherein
the controller causes the temperature of the heat transmission medium to be lowered to lower the temperature of the stack, when the power generation output of the stack is reduced.

8. The polymer electrolyte fuel cell system according to claim 6, wherein
the controller includes:
a memory unit for storing data which associates the power generation output of the stack with a set value of the controlled target which does not cause occurrence of an unstable state of the power generation output of the stack at the power generation output; and
a control unit configured to control the heat transmission medium supplier to cause the controlled target to become the set value, based on the data.

9. The polymer electrolyte fuel cell system according to claim 1, wherein
the cathode gas channels are formed such that a plurality of grooves extend in parallel and in a serpentine form from an inlet thereof to an outlet thereof and the grooves extending in parallel is reduced in number in a direction from the inlet to the outlet.

10. The polymer electrolyte fuel cell system according to claim 1, wherein when the power generation output of the stack is reduced, the controller controls at least one of the anode gas supplier and the cathode gas supplier to increase a humidification amount of at least one of the anode gas and the cathode gas to increase a dew point temperature of at least one of the anode gas and the cathode gas.

11. The polymer electrolyte fuel cell system according to claim 1, wherein before the controller controls at least one of the anode gas supplier, the cathode gas supplier, and the temperature control device to reduce the power generation output of the stack, the controller sets the dew point temperature of the gas supplied to at least one of the anode gas channels and the cathode gas channels to be higher than the temperature of the stack; and wherein when the power generation output of the stack is reduced, the controller causes the dew point temperature of the gas to be higher relative to the temperature of the stack so that said gas becomes supersaturated or more supersaturated than prior to causing the dew point temperature of said gas to be higher.
